(19) United States
(12) Patent Application Publication
(10) Pub. No.: US 2009/0091200 A1
(43) Pub. Date: Apr. 9, 2009

(54) ROTOR WITH A THERMAL BARRIER AND A MOTOR WITH SUCH A ROTOR

(75) Inventor: Niels Christian Weihrauch, Flensburg (DE)

Correspondence Address: MCCORMICK, PAULDING & HUBER LLP, CITY PLACE II, 185 ASYLUM STREET, HARTFORD, CT, 06103, US

(73) Assignee: Danfoss Compressors GmbH, Flensburg (DE)

(21) Appl. No.: 12/280,819

(22) PCT Filed: Mar. 2, 2007
(86) PCT No.: PCT/DE2007/000433

§ 371 Date: Dec. 3, 2008

(30) Foreign Application Priority Data
Mar. 2, 2006 (DK) PA 2006 00302

(51) Int. Cl. H02K 9/00; H02K 9/02

(52) U.S. Cl. 310/61; 310/52

(57) ABSTRACT

The invention provides an electrical line-start motor comprising with a stator and a squirrel cage rotor adapted for rotation around a centre axis. The rotor comprises a squirrel cage winding in which a current is induced by corresponding windings of the stator, and a set of permanent magnets. To protect the magnets from excessive heat, the rotor comprises thermal barriers e.g. in the form of cavities located between the squirrel cage winding of the rotor and the magnets. Due to the thermal barriers, the thermal conductivity in a path between the windings and the magnets are reduced and the magnets are protected.

### CROSS REFERENCE TO RELATED APPLICATIONS

This application is entitled to the benefit of and incorporates by reference essential subject matter disclosed in International Patent Application No. PCT/DE2007/000433 filed on Mar. 2, 2007 and Danish Patent Application No. PA 2006 00302 filed Mar. 2, 2006.

### TECHNICAL FIELD

The invention relates to a rotor and an electrical line-start motor comprising a stator with a stator winding and a squirrel cage rotor adapted for rotation around a centre axis. The rotor comprises a core with a set of longitudinally extending windings which are electrically connected by at least one short-circuit ring, and at least one permanent magnet is located in a cavity of the rotor.

### BACKGROUND OF THE INVENTION

In one type of commonly used electrical motors, a stator comprises a stator winding or several windings in which an electrical field creates a rotating magnetic field. Inside, or circumferentially outside the stator, a rotor is rotationally attached to rotate under influence of the magnetic field. Various principles exist. In a synchronous motor, the rotor is magnetised, or comprises a set of permanent magnets. This type of motor is simple and reliable, and the rotational speed of the rotor corresponds to the rotational speed of the electrical field in the windings of the stator. In certain applications, however, the synchronous motor has an inappropriate start-up characteristic. In asynchronous motors, the rotor comprises substantially longitudinally extending windings which in axially opposite ends of the rotor are interconnected by short circuit rings. Typically, a rotor for an asynchronous motor comprises a rotor core made from a magnetically conductive material and a squirrel cage wherein the windings and short circuit rings are moulded in one piece from an electrically conductive material, e.g. aluminium. The rotor could be laminated from sheets of a metal, wherein each sheet comprises an opening which, in combination with other sheets, form conductor slots extending axially through the rotor. After the assembly of the sheets into a rotor core, conductive bars, constituting the windings are moulded directly into the conductor slots using the slots as a mould, and the short circuit rings are moulded as an integral part of the bars. In use, an electrical current is induced into the windings of the rotor by the magnetic field generated in the stator, and due to a shift between the electrical field in the windings of the stator and in the windings of the rotor, the rotor starts to rotate. Such motors have good start-up characteristics but in order to continue the induction of an electrical field into the windings of the rotor, the electrical field of the stator must move relative to the windings of the rotor. The rotational speed of the rotor will therefore always be lower than the rotational speed of the electrical field in the stator.

A squirrel cage functions as a winding in a rotor, and in a line start motor, the purpose of the squirrel cage is to start rotation of the rotor and in combination with permanent magnets, to synchronise the speed of the rotor with the speed of the stator magnetic field. As long as a difference in rotational speed of the rotor and rotational speed of the magnetic field exists, the magnetic field from the stator induces a current in the squirrel cage and therefore the rotor continues to accelerate. When the speed of the rotor approaches the speed of the magnetic field from the stator the permanent magnets takes over the torque pulsation and cause synchronisation. Subsequently, the current in the squirrel cage is zero and the motor is now operating as a synchronised machine.

Magnets are normally sensitive to increased temperatures, and depending upon the quality of the magnets, they are destroyed at temperatures in the range of 100-180 degrees Celsius. More heat resistant magnets are expensive.

In a line-start motor, the temperature may reach 300 degrees Celsius, but temperatures in the range of 200-250 degrees are more common. A line start motor must normally be designed for temperatures up to as an example 160 degrees to avoid demagnetisation of the permanent magnets and thus malfunction of the motor.

### BRIEF SUMMARY OF THE INVENTION

It is an object of the invention to improve the existing line-start motors. In a first aspect, the invention provides a rotor comprising at least one thermal barrier located between each magnet and the winding. In this context, the word thermal barrier denotes any structural feature which reduces thermal conductivity between the magnet and the winding relative to the thermal conductivity without the thermal barrier.

During operation of a line-start motor, heat is generated by the winding mainly in the area between the winding and the magnets. The heat is generated when the stator by magnetism induces an electrical current in the axially extending conductive bars which forms the winding of the rotor. Due to the thermal barrier, the thermal resistance through the rotor in a path between the stator and the magnets is increased. Accordingly, the temperature of the magnets will be reduced and the motor may be protected against demagnetisation of the permanent magnets.

Location of any kind of thermal barrier, i.e. a structure which has a lower thermal conductivity than the remaining part of the rotor may reduce the magnetic flux in the core of the rotor. This, however, can be compensated by use of thicker or stronger magnets.

The rotor winding could form a squirrel cage winding or the rotor could be a winded rotor comprising one or more phase windings, e.g. located in axial slots along the peripheral edge of the rotor. Normally such motors comprise a plurality of circumferentially spaced magnets and correspondingly the rotor may comprise a plurality of circumferentially spaced thermal barriers, e.g. one thermal barrier for each magnet.

To introduce certain design considerations, it is necessary to introduce a 2-dimensional projection plane, i.e. a plane which can be determined by three non-collinear points. The plane is located between one of the magnets and a corresponding thermal barrier, and the plane is perpendicular to a radial axis defined as an axis which extends perpendicularly from the centre axis through a geometric centre of the magnet towards the peripheral rim of the rotor. It may improve the motor if the thermal barriers are dimensioned so that a projection of the thermal barrier along the radial axis onto the plane has a size of at least 50% of the size of a projection of the magnet along the radial axis onto the plane.

The thermal barrier may be formed as an air gap, i.e. a cavity or slit in the core which is filled with atmospheric air or which is filled with a gas which is heavy relative to atmospheric air or which is evacuated at least partly. Due to the thermal conductivity of air, which conductivity is lower than the thermal conductivity of the metal of the core, the air forms a thermal barrier. Alternatively, the thermal barrier may be formed by a foam material such as polyurethane foam or in general by any material with a thermal conductivity which is lower than the thermal conductivity of the core.

If the thermal barrier is an air gap, the air may be enclosed in a sealed cavity whereby exchange with air of the ambient space is prevented. Alternatively, the air gap is in fluid communication with ambient space via openings in at least one of the end faces. If the air gap forms an opening in both of the end faces, the air passage extending between the openings may extend linearly in the axial direction of the rotor or the passages may be helically coiled around the centre axis. This may facilitate creation of an air stream through the rotor during rotation of the rotor around the centre axis. In that way, the exchange of air in the passages may improve cooling of the magnets further.

The rotor typically comprises a centre opening in which a crank shaft is located. Since the magnets typically are positioned deep below the rotor surface, close to the centre opening, it may improve the magnetic field from the magnets if the crank shaft has magnetic conductive characteristics.

If the rotor is laminated, the aforementioned cavity can be made by stacking rotor plates of a second type which has through going openings which form the cavity when the plates are stacked. If the cavity should be sealed, this may be accomplished by attaching rotor plates of a first type, i.e. without the through going openings, to axial opposite ends of a stack of plates of the second type. In an alternative embodiment, the rotor stack may contain plates of the two types alternatingly whereby a plurality of closed cavities is formed along the axial length of the rotor.

To further improve the protection of the magnets, the distance between the thermal barrier and the magnet may preferably be smaller than a thickness of the magnet, and it may even be smaller than ⅓ of the thickness of the magnet. The distance could e.g. be in the range of one half to one third of the thickness of the magnets in the radial direction from the centre axis towards the peripheral rim of the core. In this way, the thermal barriers are very close to the magnets and the ratio between the degree of damping of the magnetic flux in the core and the thermal conductivity is improved.

The reduction of the thermal conductivity depends on the width of the thermal barriers. A typical choice of the width is in the size of ⅓ of the width of the magnets.

In one embodiment, the shape of the thermal barrier in a cross-section perpendicular to the centre axis is quadrangular or rectangular, or the thermal barrier may form at least two axially opposite end surfaces and four side surfaces. Two of the side surfaces may be plane surface which are perpendicular to the radial direction from the centre axis towards the peripheral rim of the rotor. The other two surfaces may be smoothly rounded, e.g. semi-circularly rounded with a diameter corresponding to the distance between the two plane side surfaces. Alternatively, the thermal barrier may e.g. have essentially the same shape as the magnets.

The rotor could be tubular with an inner peripheral surface and an outer peripheral surface. If the rotor is internal, the outer peripheral surface is towards the stator, and if the rotor is an external rotor, the inner peripheral surface is towards the stator. In any case, it may be an advantage if the distance from the magnet to the windings is larger than the distance from the magnet to the one of the outer or inner peripheral surface which is not towards the stator. In a motor with an internal rotor which is solid cylindrical, i.e. with a rotor without an inner peripheral surface, the distance from the magnet to the windings is larger than the distance from the magnet to the centre axis.

In addition to the thermal barriers, the motor could further comprise ventilation passages or gaps, e.g. gaps which are adapted to create a forced stream of air through the rotor when it rotates. In one simple embodiment, the air gaps are passages extending between the axially opposite end surfaces of the rotor. The ventilation gaps could advantageously be located between the stator and the magnets to conduct heat away from the passage between the stator and the magnets, or they could be located between the magnets and the crank shaft extending through the rotor. In one embodiment of the invention, the rotor therefore comprises axially extending open air passages and closed cavities containing a medium with a thermal conductivity which is lower than the thermal conductivity of the material of the core.

In a second aspect, the invention provides a motor with a rotor according to the first aspect of the invention.

In a third aspect, the invention provides a method of protecting magnets in a rotor for a line-start motor, said method comprising:
providing a rotor adapted for rotation around a centre axis and comprising a core with axially opposite end faces and a set of windings extending between the end faces,
providing at least one permanent magnet in a cavity of the rotor, and
providing at least one thermal barrier between each magnet and the winding.

The method may include any step implicit considering the above description of the first aspect of the invention.

### BRIEF DESCRIPTION OF THE DRAWINGS

In the following, a preferred embodiment of the invention will be described in further details with reference to the drawing in which:

FIG. 1 illustrates a cross-sectional view of a rotor for a line-start motor,

FIG. 2 illustrates a rotor plate of a first type for a rotor in a line-start motor,

FIG. 3 illustrates a plate of a second type for a rotor according to the invention,

FIG. 4 illustrates an enlarged view of a magnet and a thermal barrier, and

FIG. 5 illustrates an enlarged view of a large magnet and corresponding thermal barriers.

### DETAILED DESCRIPTION OF THE PREFERRED EMBODIMENTS

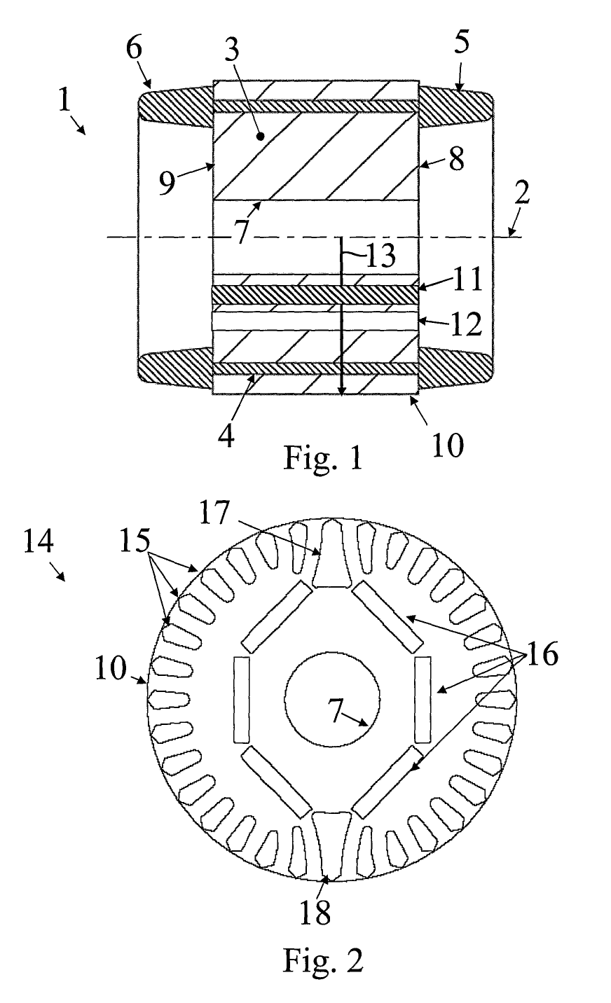

FIG. 1 illustrates a cross-section of a squirrel cage rotor 1 which is adapted for rotation around a centre axis 2. The rotor 1 comprises a core 3 made from magnetically conductive metal plates which are shown in FIG. 2. The plates are stacked and joined to form the core 3. The core comprises a squirrel cage winding 4 comprising a plurality of conductive bars which extend axially between short circuit rings 5, 6. The rotor comprises an internal bearing surface 7 in which a crank shaft (not shown) is inserted. The end faces 8, 9 of the rotor may form openings into ventilation gaps and may further form openings into cavities in which the magnets are located. The end faces may further form openings into the thermal barriers. The peripheral rim 10 is circular in a cross-section perpendicular to the centre axis 2. The rotor comprises plurality of circumferentially space magnets 11 and corresponding thermal barriers 12. Only one magnet and one thermal barrier is visible in the cross-section.

The arrow 13 illustrates a radial axis defined as an axis which extends perpendicularly from the centre axis 2 through a geometric centre of the magnet 11 towards the peripheral rim 10 of the rotor.

FIG. 2 shows a plate 14 of a first type which may form one of the end faces 8, 9 of the rotor. The plate 14 comprises openings 15 are provided for the axially extending bars which form the squirrel cage winding 4. The bars are electrically connected by the short-circuit rings 5, 6 (c.f. FIG. 1) in the axially opposite ends of the rotor. Permanent magnets are located in cavities formed by the openings 16 in the rotor. The rotor is adapted for rotation around the centre axis 2. To fit a rotational axle into the rotor for suspending the rotor rotationally within the stator, the rotor is tubular with an inner peripheral surface forming the bearing surface 7 and an outer peripheral surface forming the peripheral rim 10 or the rotor. The openings 17, 18 are also provided for the bars which form the winding.

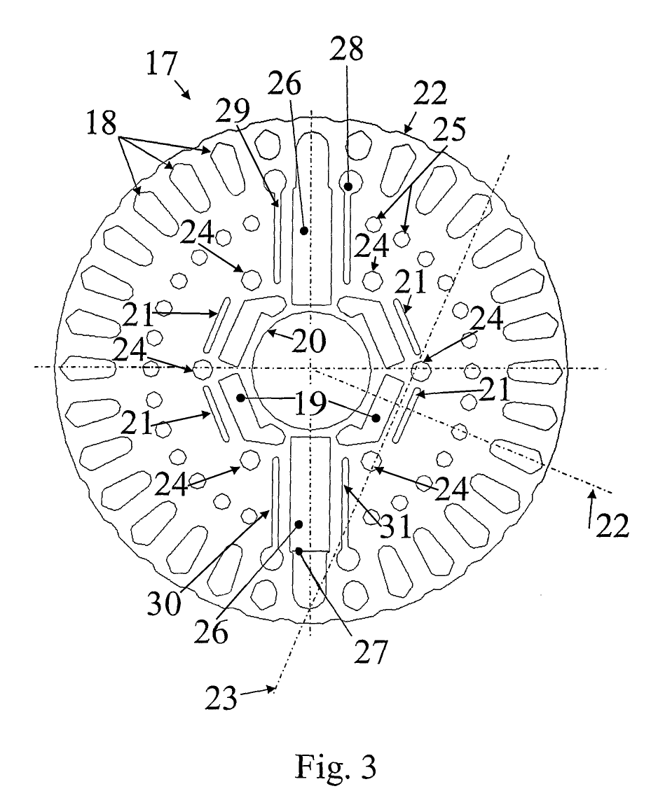

FIG. 3 illustrates another plate 17 of a second type which forms a main portion of the core between the end faces 8, 9. In an alternative embodiment, plates of the second type form the entire core of the rotor according to the invention. Similar to the plates of the first type, the plates of the second type comprises openings 18 for the axially extending bars forming the squirrel cage windings 4, openings 19 for the magnets 11, and an opening 20 for the crank shaft. In addition to these openings, the plate of the second type has openings 21 which, when stacked, form the thermal barrier. The openings 21 form cavities which are filled with atmospheric air, filled with a gas which is heavy relative to atmospheric air or filled with any other material which has a lower thermal conductivity than the material from which the plates are made.

The dotted line 22 illustrates a radial axis defined as an axis which extends perpendicularly from the centre axis 2 through a geometric centre of a magnet 11 (located in the cavities formed by the openings 19) towards the peripheral rim 10 of the rotor, c.f. also the arrow 13 in FIG. 1. The dotted line 23 illustrates a 2-dimensional projection plane, i.e. a plane which can be determined by three non-collinear points. The plane is located between one of the magnets and a corresponding thermal barrier. As shown, the plane is perpendicular to the radial axis illustrated by the dotted line 22.

In the disclosed embodiment the thermal barriers are dimensioned so that a projection of the thermal barrier along the radial axis onto the plane has a size of close to 100 pct. of the size of a projection of the magnet along the radial axis onto the plane. A size of the projection of the thermal barrier of at least 50% of the size of the projection of the magnet is desirable in order to protect the magnet from the impact of the heat generated in the bars forming the winding 4.

Ventilation gaps 24 form openings in the end faces and extends between the end faces through the rotor. The ventilation gaps are located between the thermal barriers. The ventilation gaps provide a stream of air axially through the rotor to cool down the rotor while the air gaps form an area of low thermal conductivity to reduce thermal conduction from the winding to the magnets. The ventilation gaps 24 additionally function as flux barriers for the magnets.

An additional row of circumferentially spaced ventilation gaps 25 form openings in the end faces. Whereas the thermal barriers could form closed cavities which reduce thermal conductivity in accordance with principles of isolation in a double glazed window, the ventilation gaps cools the rotor down by transporting a stream of air through the rotor. Accordingly, the air gaps of the closed type and the ventilation gaps serve to protect the magnets in two completely different ways.

Two particularly large openings 26, 27 form cavities for magnets. The radially outer most portion of the openings are filled with air or aluminium casting into the openings during casting of the squirrel cage in which case the openings must be divided into two compartments by a narrow bridge portion 27 (only shown in one of the disclosed two openings). The large magnets are located between large thermal barriers 28-31.

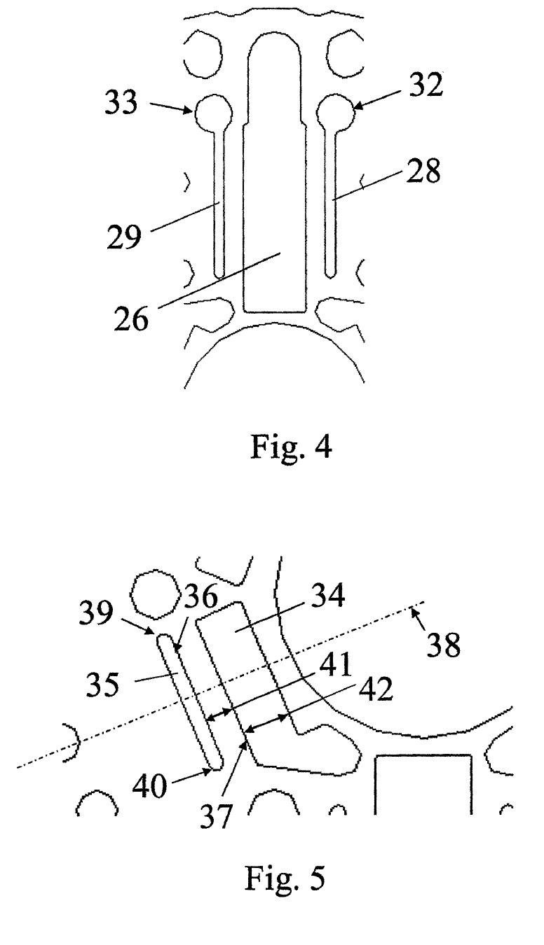

FIG. 4 shows an enlarged view of the large magnets 26, c.f. FIG. 3. In this view it is seen that the large thermal barriers 28-31 ends radially outwardly in circular segments 32, 33. The circular segments facilitate the production by improving the life-time of the puncher in the stamping tool which is used for manufacturing of the plates.

FIG. 5 shows an enlarged view of a magnet 34 and a corresponding thermal barrier 35. The thermal barrier 35 comprises a surface 36 which is parallel to a surface 37 of the magnet 34. Correspondingly, that edge of the air gaps is essentially of a length corresponding to the length of the parallel edge of the magnets. Moreover, that edge of the air gaps is essentially perpendicular to a radial direction from the centre axis towards the peripheral rim of the rotor. The radial direction is indicated by the dotted line 38.

As shown in FIG. 5, the thermal barrier 35 comprises two parallel edges and two semi-circular end faces 39, 40 with a diameter corresponding to the width of the thermal barrier. The segment 41 between the surfaces 36, 37 has width (i.e. a length of a line extending perpendicular to the surfaces 36, 37 between a point on each surface) which is smaller than the thickness of the magnet along the radial axis; this thickness is indicated by the arrow 42.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A rotor for an electrical line-start motor, the rotor comprising:
a rotor adapted for rotation around a centre axis and comprising a core with axially opposite end faces and a rotor squirrel cage winding,
a plurality of permanent magnets and thermal barriers located in the core, the thermal barriers being located between each magnet and the squirrel cage winding, and having a thermal conductivity which is lower than the thermal conductivity of the core.

2. The rotor according to claim 1, wherein a projection of one of the thermal barriers onto a projection plane which is located between a magnet and the thermal barrier has an area which constitutes at least 50% of a projection of one of the magnets onto the projection plane.

3. The rotor according to claim 1, wherein the thermal barriers are located closer to the magnets than to the squirrel cage winding.

4. The rotor according to claim 1, wherein the thermal barriers have a rectangular shape in a cross-section perpendicular to the centre axis.

5. The rotor according to claim 1, wherein each thermal barrier extends through the rotor between openings in each end face.

6. The rotor according to claim 1, wherein at least one thermal barrier is formed by a cavity containing atmospheric air or a gas which is heavier than atmospheric air.

7. The rotor according to claim 6, wherein the cavity is helically coiled around the centre axis to create an air stream through the cavity during rotation of the rotor around the centre axis.

8. The rotor according to claim 1, wherein the magnets and thermal barriers comprises parallel adjacent surfaces.

9. The rotor according to claim 8, wherein a length of a segment perpendicular to the surfaces with an end point on each surface is shorter than the thickness of the magnets along the radial axis.

10. The rotor according to claim 8 wherein the surfaces are perpendicular to a radial axis extending from the centre axis to the periphery of the rotor.

11. The rotor according to claim 1, further comprising ventilation passages located between the squirrel cage winding and the thermal barriers or between the magnets and a crank shaft, the ventilation passages extending through the rotor to form passages between openings in each axially opposite end face of the rotor.

12. The rotor according to claim 11, further comprising ventilation gaps located circumferentially spaced between two circumferentially adjacent thermal barriers.

13. The rotor according to claim 12, wherein the ventilation passages extends helically coiled around the centre axis.

14. A line-start motor comprising a rotor according to claim 1.

15. A method of protecting magnets in a rotor for a line-start motor, said method comprising:
providing a rotor adapted for rotation around a centre axis and comprising a core with axially opposite end faces and a squirrel cage winding,
providing at least one permanent magnet, and
providing a thermal barrier between the squirrel cage winding and the magnet.
